(19) United States
(12) Patent Application Publication
(10) Pub. No.: US 2023/0292197 A1
(43) Pub. Date: Sep. 14, 2023

(54) ENABLING 5G TO 4G TO 3G MOBILITY FOR PROTOCOL DATA UNIT (PDU) SESSIONS THAT ARE CREATED OR MODIFIED IN 5G

(71) Applicant: Cisco Technology, Inc., San Jose, CA (US)

(72) Inventor: Irfan Ali, Palo Alto, CA (US)

(21) Appl. No.: 17/691,721

(22) Filed: Mar. 10, 2022

(51) Int. Cl. H04W 36/00

(52) U.S. Cl. CPC H04W 36/0085

(57) ABSTRACT

A control plane function entity for session management is operative to enable 5G to 4G to 3G mobility for a user equipment (UE). Initially, the entity may communicate one or more messages in a procedure for a handover of a session of the UE from a Fifth Generation System (5GS) to an Evolved Packet System (EPS). The entity may identify whether one or more indications indicate a need to provide 2G and/or 3G parameters. Based on identifying the one or more indications, the entity may communicate one or more messages in a bearer modification procedure with a bearer Quality of Service (QoS) update. In some implementations, the control plane function entity may identify the need to provide the 2G and/or the 3G parameters when the session is originally established in 5GS or when QoS parameters of a QoS Flow of the session are modified while the UE was in 5GS.

### TECHNICAL FIELD

The present disclosure relates generally to telecommunications systems, and more particularly to techniques and mechanisms for enabling 5G to 4G to 3G mobility for protocol data unit (PDU) sessions that are created or modified in 5G.

### BACKGROUND

Traditionally, cellular networks have been designed to provide communications for mobile devices or user equipment (UE) according to Third Generation Partnership Project (3GPP) standards, such as Fourth Generation (4G)/Long Term Evolution (LTE)/Evolved Packet Core (EPC) standards. The 3GPP-defined EPC of the Evolved Packet System (EPS) includes a Mobility Management Entity (MME), a Packet Data Network (PDN) Gateway (PGW), and a Serving Gateway (SGW). In a more advanced Control and User Plane Separation (CUPS) architecture of the EPC, the PGW may be separated into a PGW-Control Plane (PGW-C) and a PGW-User Plane (PGW-U), and the SGW may be separated into a SGW-Control Plane (SGW-C) and a SGW-User Plane (SGW-U).

Today, cellular networks are being upgraded or migrated to Fifth Generation (5G) technology. A 5G System (5GS) utilizes radio access technologies (RATs)/radio access network (RAN) technologies and core functions that are different from the EPS. A 5G deployment is based on the 5G Core (5GC) defined in the 3GPP specifications, and includes functions such as an Access and Mobility Management Function (AMF), a Session Management Function (SMF), and a User Plane Function (UPF).

Interworking between 4G and 5G will play an important role in the deployment of 5G, which will initially rely on the 4G/LTE/EPC as its underlying system. In the 3GPP architecture for interworking, “combined” or “converged” components are provided for implementing what is referred to as a “converged 4G/5G network.” For example, the SMF and the PGW-C may be provided as a combined entity (i.e., an SMF+PGW-C), and the UPF and the PGW-U may be provided as a combined entity (i.e., a UPF+PGW-U). Here, the SMF+PGW-C may operate to maintain a control signalling session, via an N4/Sx interface, with the UPF+PGW-U for managing a Packet Data Unit (PDU) session/PDN connection for the UE. Since the SMF+PGW-C may serve as a dedicated control plane “anchor” for the PDU session/PDN connection, seamless session continuity and IP address preservation are possible for a UE moving from one system to the other.

Thus, mobility for UEs is supported between 5G and 4G systems using handover and idle mode mobility mechanisms described in current 3GPP specifications. Note that mobility for UEs between 4G and Third Generation (3G) systems is already currently supported as described in the 3GPP specifications.

Looking ahead, 3GPP Release 17 will provide general, end-to-end support for 5G to 4G to 3G mobility. When a UE moves from 5G to 4G to 3G (i.e., from 5G to 4G, then from 4G to 3G), however, the 3GPP Release 17 specification does not provide for IP address preservation for PDU sessions created in 5G, i.e., in the 5G Standalone (SA) architecture. In addition, the 3GPP Release 17 specification does not properly handle Quality of Service (QoS) Flows that are modified while the UE is in 5GS.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is an illustrative representation of a Third Generation Partnership (3GPP) based mobile network having a converged core architecture for interworking between an Evolved Packet System (EPS) and a Fifth Generation (5G) System (5GS), enabling 5G to 4G mobility for a user equipment (UE);

FIG. 2 is another illustrative representation of the 3GPP-based mobile network having the converged core architecture for interworking between the EPS and the 5GS of FIG. 1, showing further a session of the UE being handed over from the EPS to the 5GS;

FIG. 3 is an illustrative representation of a 3GPP-based mobile network having a converged core architecture for interworking between a Third Generation (3G)/Second Generation (2G) system, the EPS, and the 5GS, generally enabling 5G to 4G to 3G/2G mobility for the UE;

FIGS. 4A, 4B, and 4C form a call flow diagram for describing a call flow for managing a session of a UE for handover from a 5GS to an EPS according to some implementations;

FIG. 5A is a flowchart for describing a method for use in enabling 5G to 4G to 3G mobility for protocol data unit (PDU) sessions that are created or modified in 5G, which may be facilitated by a control plane function entity for session management, according to some implementations of the present disclosure;

FIG. 5B is a call flow diagram for describing a call flow for enabling 5G to 4G to 3G mobility for PDU sessions that are created or modified in 5G, which may be facilitated by the control plane function entity for session management, according to some implementations of the present disclosure;

FIG. 6A is a flowchart for describing a method for use in enabling 5G to 4G to 3G mobility for PDU sessions that are created or modified in 5G, which may be facilitated by a control plane function entity for mobility management, according to some implementations of the present disclosure;

FIG. 6B is a call flow diagram for describing a call flow for enabling 5G to 4G to 3G mobility for PDU sessions that are created or modified in 5G, which may be facilitated by the control plane function entity for mobility management, according to some implementations of the present disclosure; and

FIG. 7 illustrates a hardware block diagram of a computing device that may perform functions associated with operations of a control plane function entity according to some implementations of the present disclosure.

### DESCRIPTION OF EXAMPLE EMBODIMENTS

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

### Overview

Techniques and mechanisms for enabling 5G to 4G to 3G mobility for protocol data unit (PDU) sessions that are created or modified in 5G are described herein.

In one illustrative example, a control plane function entity for session management is operative to enable 5G to 4G to 3G mobility for a user equipment (UE). Initially, the control plane function entity may communicate one or more messages in a procedure for a handover of a session of the UE from a Fifth Generation System (5GS) to an Evolved Packet System (EPS). After the procedure for the handover, the control plane function entity may identify whether one or more indications indicate a need to provide 2G and/or 3G parameters. Based on identifying the one or more indications, the control plane function entity may communicate one or more messages in a bearer modification procedure with a bearer Quality of Service (QoS) update. In some implementations, the control plane function entity may identify the need to provide the 2G and/or the 3G parameters when the session is originally established in 5GS or when QoS parameters of a QoS Flow of the session are modified while the UE was in 5GS.

In another illustrative example, a control plane function entity for mobility management is also operative to enable 5G to 4G to 3G mobility for the UE. Initially, the control plane function entity may communicate one or more messages in a procedure for a handover of a session of the UE from the 5GS to the EPS. After the procedure for the handover, the control plane function entity may identify whether one or more indications indicate a need to provide 2G and/or 3G parameters. Based on identifying the one or more indications, the control plane function entity may send a message which indicates a modify bearer request including the 2G and/or the 3G parameters. In some implementations, the control plane function entity may identify the need to provide the 2G and/or the 3G parameters when the session is originally established in 5GS or when QoS parameters of a QoS Flow of the session are modified while the UE was in 5GS.

More detailed and alternative techniques and implementations are provided herein as described below.

### Example Embodiments

As described in the Background section, cellular networks have been designed to provide communications for mobile devices or user equipment (UE) according to Third Generation Partnership Project (3GPP) standards, such as Fourth Generation (4G)/Long Term Evolution (LTE)/Evolved Packet Core (EPC) standards. The 3GPP-defined EPC of the Evolved Packet System (EPS) includes a Mobility Management Entity (MME), a Packet Data Network (PDN) Gateway (PGW), and a Serving Gateway (SGW). In a more advanced Control and User Plane Separation (CUPS) architecture of the EPC, the PGW may be separated into a PGW-Control Plane (PGW-C) and a PGW-User Plane (PGW-U), and the SGW may be separated into a SGW-Control Plane (SGW-C) and a SGW-User Plane (SGW-U).

Today, cellular networks are being upgraded or migrated to Fifth Generation (5G) technology. A 5G System (5GS) utilizes radio access technologies (RATs)/radio access network (RAN) technologies and core functions that are different from the EPS. A 5G deployment is based on the 5G Core (5GC) defined in the 3GPP specifications, and includes functions such as an Access and Mobility Management Function (AMF), a Session Management Function (SMF), a Policy Control Function (PCF), and a User Plane Function (UPF).

Interworking between 4G and 5G will play an important role in the deployment of 5G, which will initially rely on the 4G/LTE/EPC as its underlying system. In the 3GPP architecture for interworking, “combined” or “converged” components are provided for implementing what is referred to as a “converged 4G/5G network.” For example, the SMF and the PGW-C may be provided as a combined entity (i.e., an SMF+PGW-C), and the UPF and the PGW-U may be provided as a combined entity (i.e., a UPF+PGW-U). Here, the SMF+PGW-C may operate to maintain a control signalling session, via an N4/Sx interface, with the UPF+PGW-U for managing a Packet Data Unit (PDU) session/Packet Data Network (PDN) connection for the UE. Since the SMF+PGW-C may serve as a dedicated control plane “anchor” for the PDU session/PDN connection, seamless session continuity and IP address preservation are possible for a UE moving from one system to the other.

Thus, mobility for UEs is supported between 5G and 4G systems using handover and idle mode mobility mechanisms described in current 3GPP specifications. Note that mobility for UEs between 4G and Third Generation (3G) systems (or between 4G and 3G/Second Generation (2G) systems) is already supported as described in the relevant 3GPP specifications.

Looking ahead, 3GPP Release 17 will provide general, end-to-end support for 5G to 4G to 3G mobility. When a UE moves from 5G to 4G to 3G (i.e., from 5G to 4G, then from 4G to 3G), however, the 3GPP Release 17 specification does not provide for IP address preservation for PDU sessions created in 5G, i.e., in the 5G Standalone (SA) architecture. In addition, the 3GPP Release 17 specification does not properly handle QoS Flows that are modified while the UE is in 5GS.

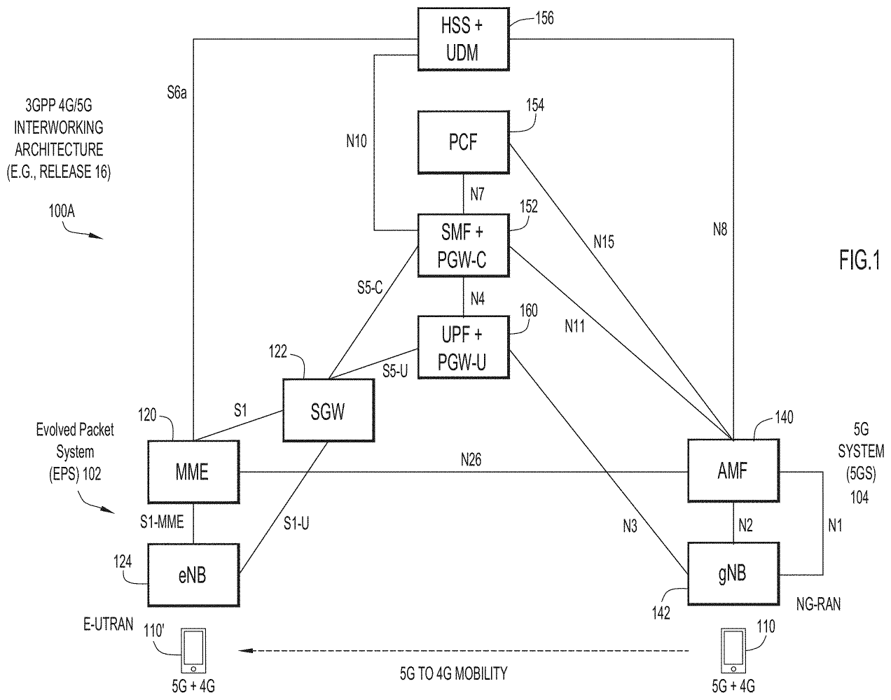

To better explain with reference to the figures, FIG. 1 is an illustrative representation of a 3GPP-based mobile network 100A having a (non-roaming) network architecture for interworking between an EPS 102 and a 5GS 104. As shown in FIG. 1, EPS 102 of 3GPP-based mobile network 100A includes an Evolved Universal Terrestrial Radio Access Network (E-UTRAN) and an EPC. At least in some contexts, EPS 102 may be referred to as a 4G system. The E-UTRAN of FIG. 1 may be for LTE-based access, and may include one or more base stations such as an eNodeB (eNB) 124. The EPC of EPS 102 may include at least an MME 120 and a SGW 122. In some implementations, the EPC of EPS 102 may include a CUPS architecture, where SGW 122 is separated into a SGW-C and a SGW-U.

Further as shown in FIG. 1, the 5GS 104 of 3GPP-based mobile network 100A includes a Next-Generation (NG) RAN (NG-RAN) and a 5GC. The NG-RAN is for 5G radio access, and may include one or more base stations such as a gNodeB (gNB) 142. The 5GC of 5GS 104 may include an AMF 140 and a PCF 154. As is apparent, different RATs and core functions are utilized between 4G and 5G. Note that standards for 5GS 104 are provided in 3GPP specifications, which include 3GPP Technical Specification (TS) 23.501 and 3GPP TS 23.502.

For interworking between 5GS 104 and EPS 102, 3GPP-based mobile network 100A may include (interworking) user plane functionality, (interworking) control plane functionality for session management, and (interworking) subscriber data management functionality. The (interworking) user plane functionality may be or include a UPF plus PGW-U 160. The (interworking) control plane functionality for session management may be or include an SMF plus PGW-C (SMF+PGW-C) 152. The (interworking) subscriber data management may be or include a Home Subscriber Server (HSS) plus a Unified Data Management (UDM) (HSS+UDM) 156.

Interfaces between the elements, functions, or modules in 3GPP-based mobile network 100A, such as interfaces for N1, N2, N3, N4, N7, N8, N10, N11, N15, N26 S1-MME, S1-U, S5-C, S5-U, and Sha, are described in relevant 3GPP specifications. In particular, the N26 interface between AMF 140 and MME 120 has been introduced to be an inter-core network (CN) interface for interworking between 5GS 104 and EPS 102.

A UE 110 is operative for communications in 3GPP-based mobile network 100A. More particularly, UE 110 may operate for communications in a selected one of EPS 102 (i.e., 4G) or 5GS 104. Here, UE 110 may be provided with radio access via the E-UTRAN (e.g., eNB 124) or the NG-RAN (e.g., gNB 142). In some implementations, UE 110 is configured to prioritize the selection of operation in 5GS 104 (i.e., prioritized over EPS 102) according to a preference or default setting, when 5G is available and configured. UE 110 may be any suitable type of device configured for communications, such as a cellular telephone, a smart phone, a tablet device, a gaming device or application, an Internet of Things (IoT) device, and a Machine-To-Machine (M2M) device, to name but a few.

In FIG. 1, UE 110 is shown to operate via the NG-RAN (e.g., gNB 142) in 5GS 104, but may subsequently need to communicate via the E-UTRAN (e.g., eNB 124) in EPS 102. Here, UE 110 may operate to switch communications to the E-UTRAN (e.g., eNB 124) in EPS 102 as a UE 110′, for example, responsive to a relocation with 5G coverage loss or even due to “EPS fallback” for a voice call.

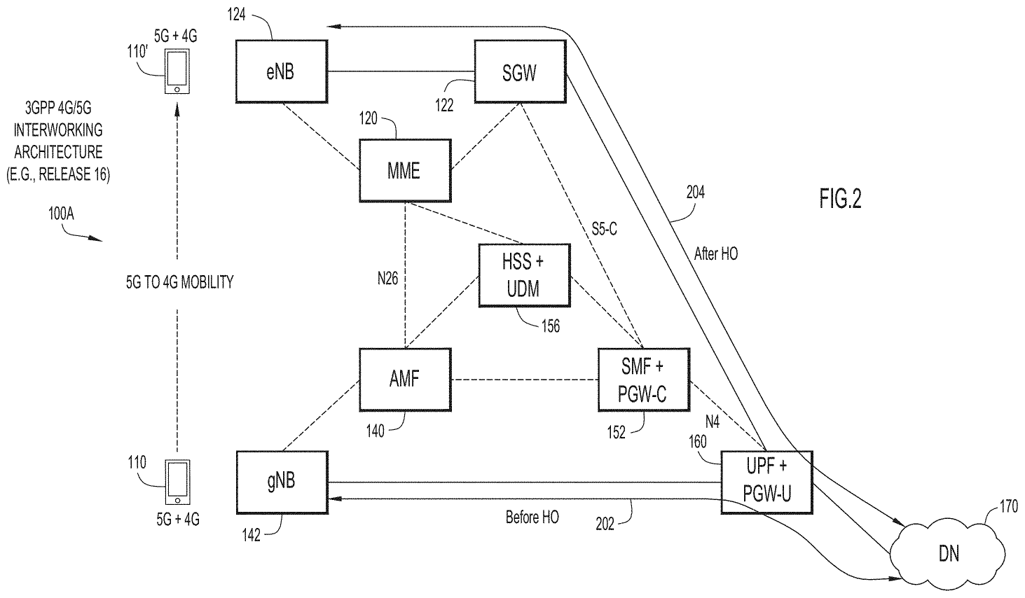

FIG. 2 is another illustrative representation of the 3GPP-based mobile network 100A having the converged core architecture for interworking between the EPS and the 5GS of FIG. 1. In FIG. 2, a session 202 of UE 110 is shown to be anchored at UPF+PGW-U 160 for communicating traffic between UE 110 and a data network (DN) 170. AMF 140 may receive a handover indication indicating a handover of the session 202 of UE 110 from the 5GS to the EPS. In response, AMF 140 may request from SMF+PGW-C 152 a session context for session 202. SMF+PGW-C 152 may then operate to establish a bearer between SGW 122 and UPF+PGW-U 160 for facilitating the handover of session 202 from the 5GS to the EPS, resulting in a session 204, providing the session context to AMF 140 for further bearer establishment. After handover from the 5GS to the EPS with the session 204, UE 110′ is shown to communicate via eNB 124 and has a NAS connection with MME 120 for operation in the EPS.

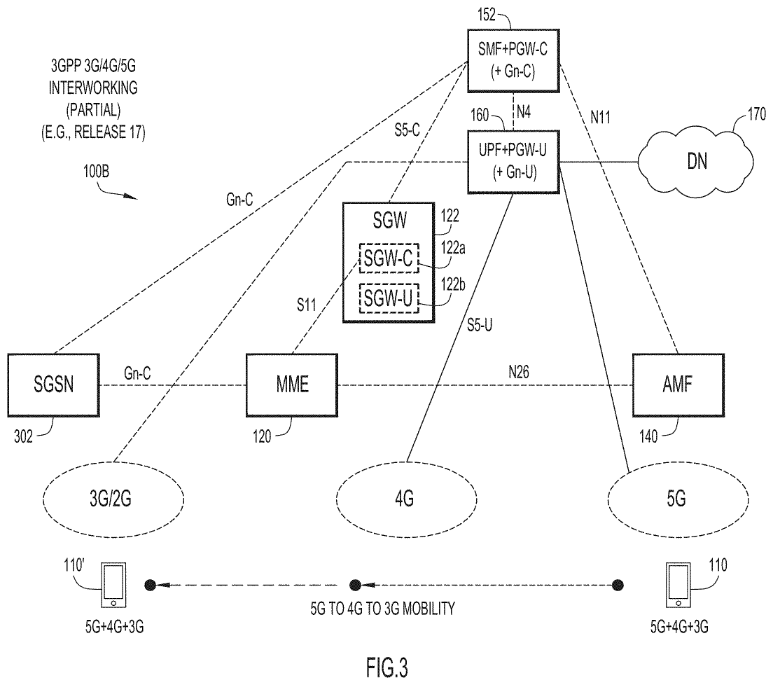

As indicated earlier, 3GPP Release 17 will provide general, end-to-end support for 5G to 4G to 3G mobility. FIG. 3 is an illustrative representation of a 3GPP-based mobile network 100B having a converged core architecture for further interworking for a 3G/2G system, the EPS, and the 5GS. This converged core architecture generally allows for 5G to 4G to 3G/2G mobility for UE 110. In 3GPP-based mobile network 100B, a Serving General Packet Radio Service (GPRS) Support Node (SGSN) 302 is provided for communication of packet-switched mobile data. SGSN 302 operates with a Gateway GPRS Support Node (GGSN) (not shown) for mobility management, billing, and management of data sessions in 2G Global Systems for Mobile Communications (GSM)/GSM EDGE Radio Access Network (GERAN) and 3G Universal Mobile Telecommunications System (UMTS) networks. For 5G to 4G to 3G/2G mobility, interworking with 2G/3G is facilitated with an Gn-C interface between the EPC control plane and SGSN 302. In preferred implementations, 3GPP-based mobile network 100B of FIG. 3 may be configured and operate in accordance with current or upcoming 3GPP Release 17 specifications. The 3GPP-based mobile network 100B of FIG. 3 also illustrates the CUPS architecture associated with the SGW 122, which is shown separated into a SGW-C 122a and a SGW-U 122b.

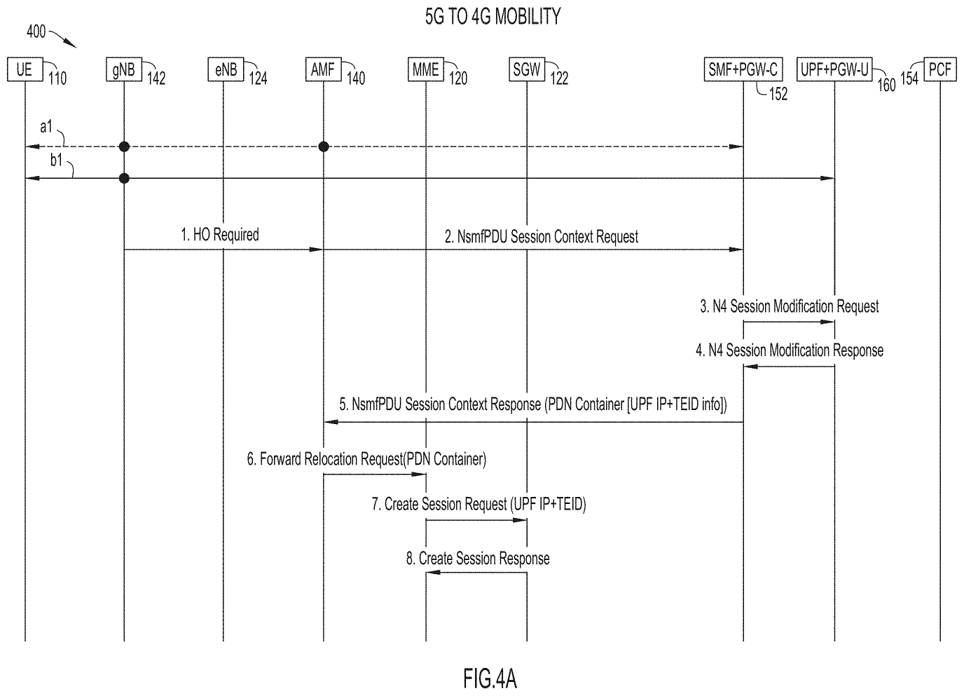

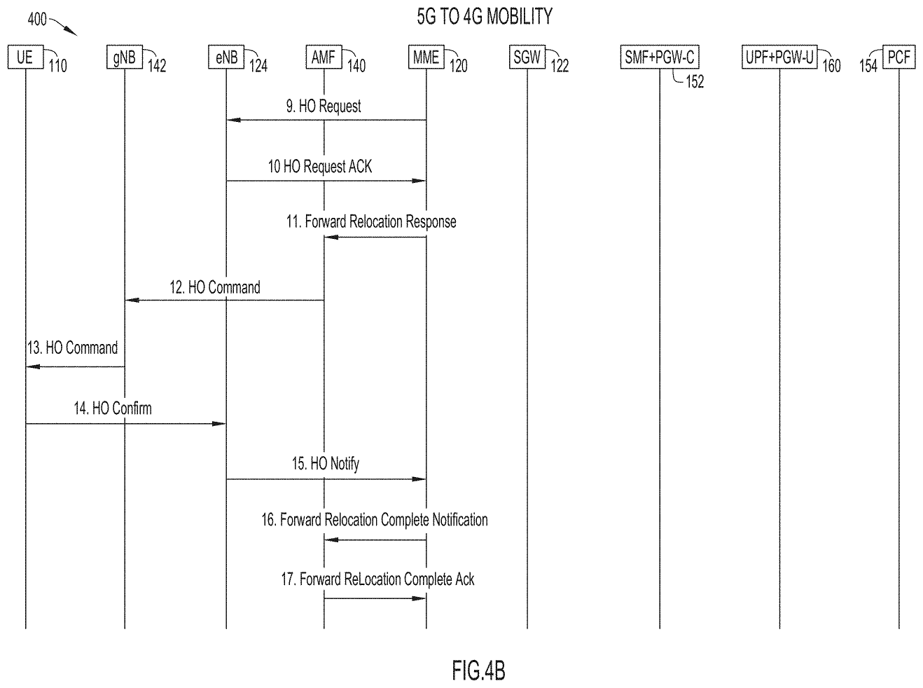

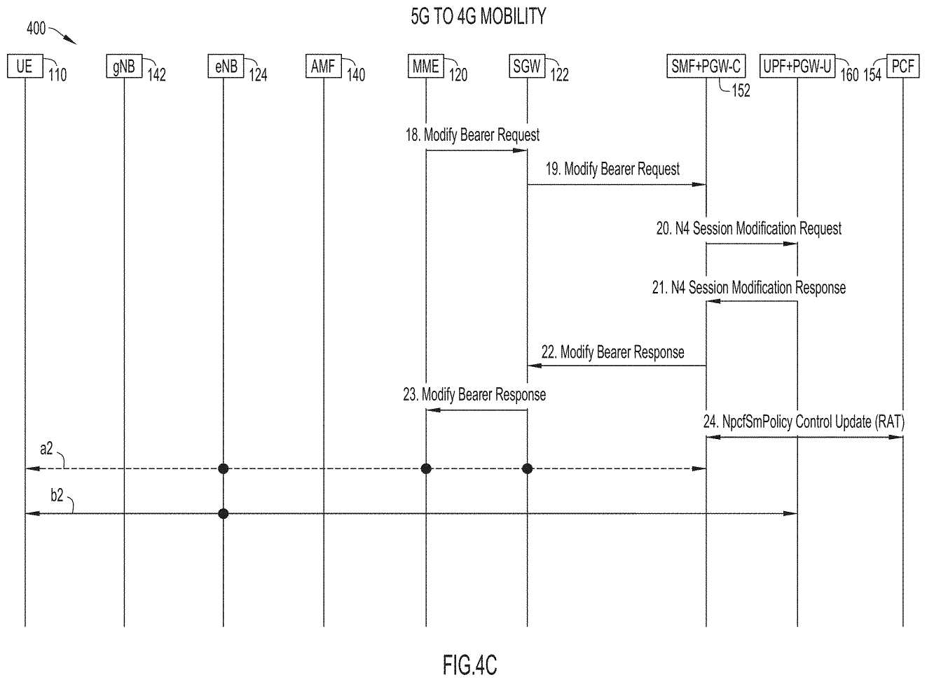

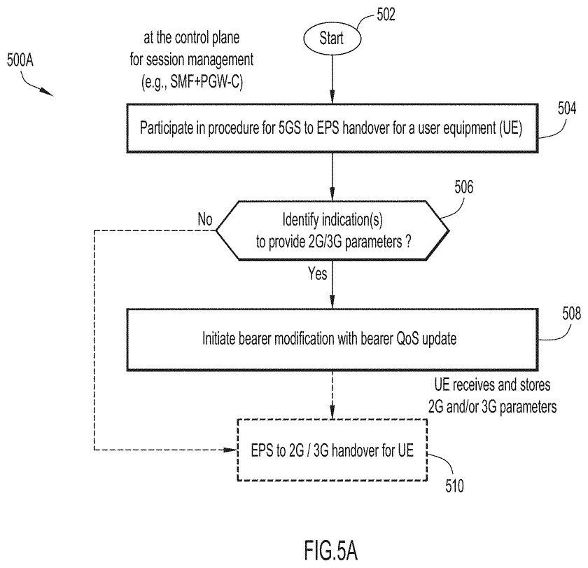

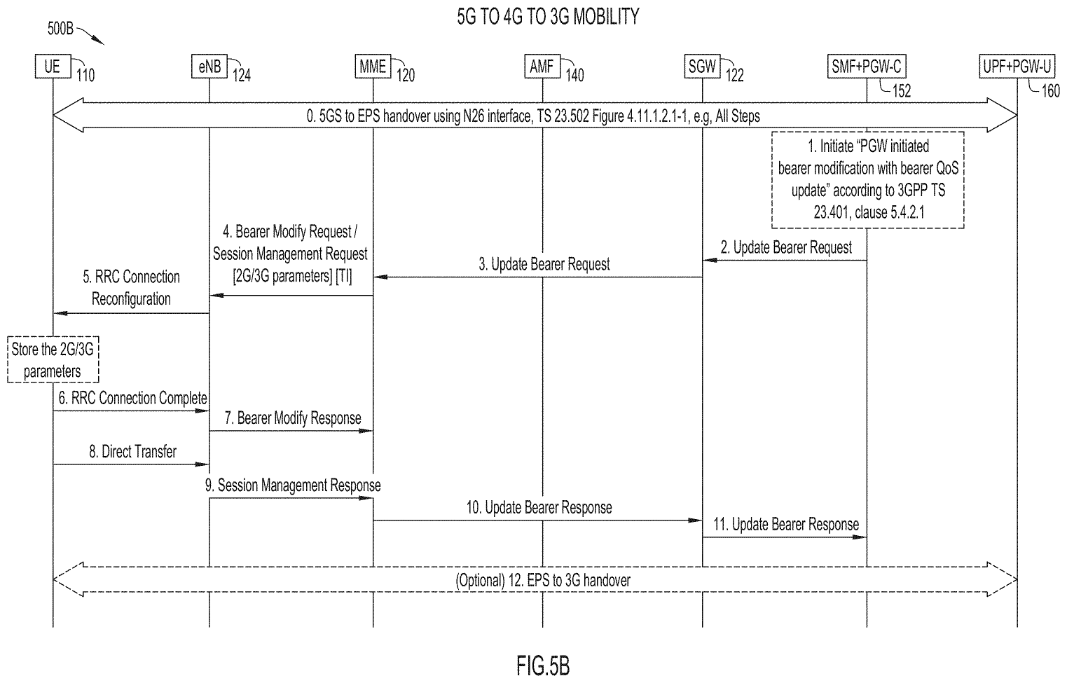

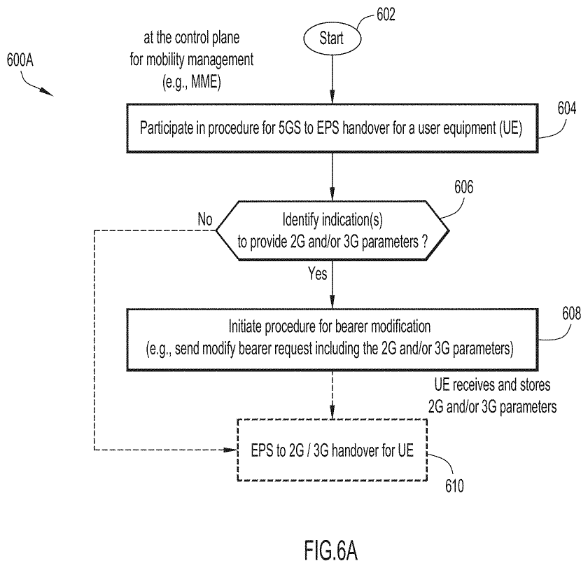

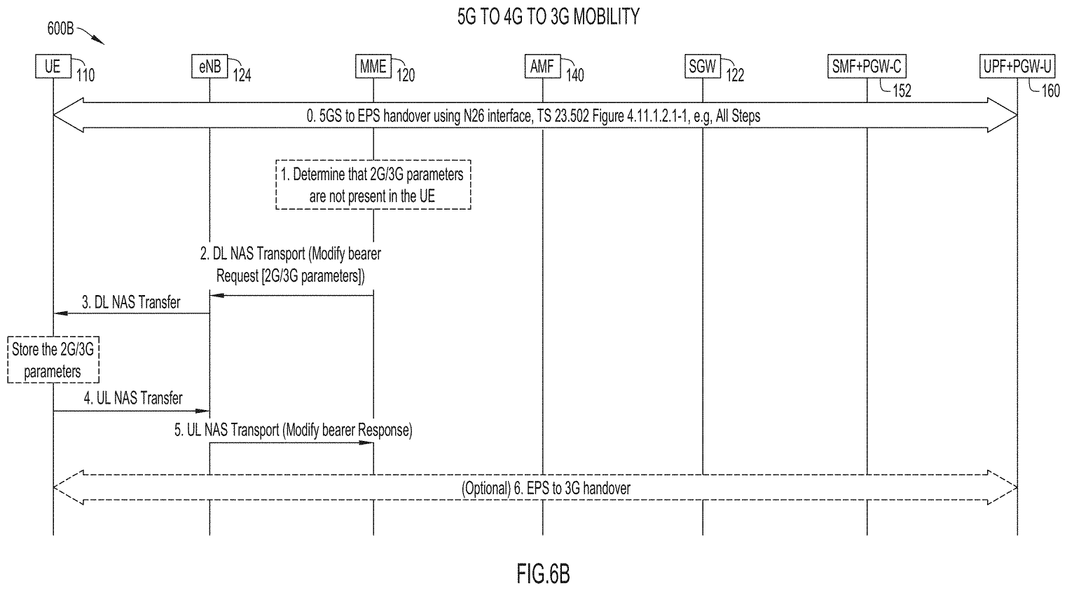

In the architecture that provides 5G to 4G to 3G/2G mobility, mobility from the 5GS to the EPS may be provided using the handover and idle mode mobility mechanisms described in the 3GPP specifications. For a general description of this procedure, FIGS. 4A, 4B, and 4C form a call flow diagram 400 of a call flow for managing a session of a UE for handover from a 5GS to an EPS according to some implementations. In some implementations, the 5GS to EPS procedure for handover may specifically follow the 5GS to EPS handover using N26 interface as specified in 3GPP TS 23.502, FIG. 4.11.1.2.1-1, e.g., all steps.

With specific reference to call flow diagram 400 in FIG. 4A, UE 110 is registered in the 5GS via gNB 142 with a session of UE 110 established for the communication of traffic. For control plane signaling, AMF 140 operates for mobility management and SMF+PGW-C 152 operates for session management (see an indicator a1 of FIG. 4A). For the user plane, the session via gNB 142 may be anchored at UPF+PGW-U 160 (e.g., the UPF) communicating traffic between UE 110 and a data network (see an indicator b1 of FIG. 4A).

A handover (HO) of the session of UE 110 from the 5GS to the EPS may be initiated, for example, based on an indication of 5G coverage loss, or EPS fallback, etc. Here, the gNB 142 may communicate to AMF 140 a message indicating HO required (step 1 of FIG. 4A). In turn, AMF 140 may send to SMF+PGW-C 152 a message indicating a session context request for requesting a session context of the session of UE 110 (step 2 of FIG. 4A). More particularly, the session context request may be an Nsmf PDU Session Context Request. SMF+PGW-C 152 may receive the message and thereby obtain the session context request.

In response, SMF+PGW-C 152 may interact with and use tunnel information of UPF+PGW-U 160 for establishing at least one bearer between UPF+PGW-U 160 and SGW 122 (or more specifically, the SGW-U in the CUPS architecture). More particularly, SMF+PGW-C 152 may perform a session modification procedure with UPF+PGW-U 160 for establishing a CN tunnel for each EPS bearer and provide EPS bearer contexts to AMF 140. See, e.g., 3GPP specification, TS 23.502, clause 4.11.1.4.1, “EPS bearer ID allocation,” in step 8 in description of the figure. More particularly, SMF+PGW-C 152 may send to UPF+PGW-U 160 a message indicating a session modification request (step 3 of FIG. 4A). The session modification request may be for establishing at least one uplink tunnel for the at least one bearer of the session. UPF+PGW-U 160 may send to SMF+PGW-C 152 a message indicating a session modification response (step 4 of FIG. 4A). The session modification response may include at least one uplink tunnel endpoint identifier of UPF+PGW-U 160 for the at least one uplink tunnel. SMF+PGW-C 152 may receive the message and thereby obtain the session modification response. More specifically, the uplink tunnel endpoint identifier may be an uplink (UL) tunnel endpoint identifier (UL TEID).

In response, SMF+PGW-C 152 may send to AMF 140 a message indicating a session context response which includes the uplink tunnel information of UPF+PGW-U 160 (step 5 of FIG. 4A). The uplink tunnel information may include an IP address and the UL TEID of UPF+PGW-U 160. More specifically, the session context response may be an Nsmf PDU Session Context Response which has a PDN Container including the IP address and the UL TED of UPF+PGW-U 160. Accordingly, for each bearer context of the PDN connection, the field “PGW S5/S8 IP Address and TEID for user plane” may contain the IP address and TEIDs allocated by UPF+PGW-U 160 that were provided to SMF+PGW-C in step 4 of FIG. 4A.

AMF 140 may receive the message and thereby obtain the session context response which includes the uplink tunnel information of UPF+PGW-U 160. In response, AMF 140 may send to MME 120 a message indicating a forward relocation request (step 6 of FIG. 4A). The forward relocation request may include the PDN Container. In response, MME 120 may send to SGW 122 a message indicating a create session request (step 7 of FIG. 4A). The create session request may include the uplink tunnel information (e.g., the IP address and the UL TED of UPF+PGW-U 160) and be for establishing the at least one uplink tunnel for the at least one bearer of the session with SGW 122. SGW 122 may send to MME 120 a message indicating a create session response (step 8 of FIG. 4A).

The call flow of FIG. 4A is continued in FIGS. 4B and 4C. With reference now to FIG. 4B, steps 9 through 17 may follow conventional message processing for 5GS to EPS handover as described in the 3GPP specifications. See, e.g., 3GPP specification, TS 23.502, clause 4.11.1.2.1, “5GS to EPS handover using N26 interface,” steps 6 through 13. In brief, in response to the create session response in step 8 of FIG. 4A, MME 120 may send to eNB 124 a message indicating a HO request (step 9 of FIG. 4B). The eNB 124 may receive and process the message, and send to MME 120 a message indicating a HO request acknowledgement message (step 10 of FIG. 4B). MME 120 may receive and process this message, and send to AMF 140 a message indicating a forward relocation response (step 11 of FIG. 4B). The forward relocation response may be provided to AMF 140 in response to the forward relocation request of step 6 of FIG. 4A. AMF 140 may send to gNB 142 a message indicating a HO command (step 12 of FIG. 4B) and, in response, the gNB 142 may send to UE 110 a message indicating a corresponding HO command (step 13 of FIG. 4B). UE 110 may receive this message and send to eNB 124 a message indicating a HO confirm (step 14 of FIG. 4B). The eNB 124 may send to MME 120 a message indicating a HO notify (step 15 of FIG. 4B). MME 120 may receive this message and, in response, send to AMF 140 a message indicating a forward relocation complete notification (step 16 of FIG. 4B). AMF 140 may receive this message and, in response, send to MME 120 a message indicating a forward relocation complete acknowledgement (step 17 of FIG. 4B).

Continuing with the call flow in FIG. 4C, in response to receiving the message in step 17 of FIG. 4B, MME 120 may send to SGW 122 a message indicating a modify bearer request (step 18 of FIG. 4C). In response, SGW 122 may send to SMF+PGW-C 152 a message indicating a modify bearer request (step 19 of FIG. 4C). SMF+PGW-C 152 may receive the message and thereby obtain the modify bearer request. The modify bearer request may include a downlink (DL) TEID of SGW 122. In response, SMF+PGW-C 152 may send to UPF+PGW-U 160 message indicating a session modification request (step 20 of FIG. 4C). The session modification request may be for establishing the at least one downlink tunnel for the at least one bearer of the session and include downlink tunnel information of SGW 122. The downlink tunnel information may include an IP address of SGW 122 and the DL TED of SGW 122. UPF+PGW-U 160 may receive and process the message, and in response, send to SMF+PGW-C 152 a message indicating a session modification response (step 21 of FIG. 4C). SMF+PGW-C 152 may receive this message and thereby obtain the session modification response. In response, SMF+PGW-C 152 may send to SGW 122 a message indicating a modify bearer response (step 22 of FIG. 4C). SGW 122 may receive and process the message, and in response, send to MME 120 a message indicating a modify bearer response (step 23 of FIG. 4C). SMF+PGW-C 152 may perform a policy control update with PCF 154 to inform PCF 154 of a change in a RAT type due to the handover (step 24 of FIG. 4C). More specifically, the policy control update may be an Npcf Sm Policy Control Update.

The handover of the session of UE 110 from the 5GS to the EPS is now complete. UE 110 may communicate in the session for the communication of traffic via eNB 124 of the EPS. For control plane signaling, UE 110 has a Non-Access Stratum (NAS) connection with MME 120, where MME 120 operates for mobility management and SGW 122 (e.g., the SGW-C) operates for session management (see an indicator a2 of FIG. 4C). For the user plane, the session may be anchored at SGW 122 (i.e., the SGW-U) connecting through UPF+PGW-U 160 (e.g., the PGW-U) for communicating traffic between UE 110 and the data network (see an indicator b2 of FIG. 4C).

As is apparent, mobility from 5G to 4G is supported as described in call flow diagram 400 of FIGS. 4A, 4B, and 4C (or, e.g., in 5GS to EPS handover using N26 interface as specified in 3GPP TS 23.502, FIG. 4.11.1.2.1-1). Although 3GPP Release 17 will further provide general, end-to-end support of 5G to 4G to 3G mobility, UE operation will fail when a UE is further handed over to 3G (i.e., 5G to 4G to 3G) without improvements to the interworking operation. More particularly, when a UE moves from 5G to 4G to 3G (i.e., from 5G to 4G, then from 4G to 3G), support for IP address preservation for PDU sessions created in 5G (i.e., in the 5G SA architecture) is not provided in 3GPP Release 17. In addition, the 3GPP Release 17 specification does not properly handle QoS Flows that are modified while the UE is in 5GS. Specifically, 3GPP TS 23.501, v.17.1.1 (June 2021) has the following sentence in Clause 5.17.2.4:
“IP address preservation at mobility from EPC to GERAN/UTRAN for PDU sessions established in 5GS is not supported.”
   For subsequent mobility to 3G to be properly facilitated, the UE should be provided with 3G QoS parameters after 5G to 4G mobility; otherwise, there will be a mismatch between the QoS parameters in the network and the QoS parameters that the UE has for 2G/3G.

Techniques and mechanisms for enabling 5G to 4G to 3G mobility for PDU sessions that are created or modified in 5G are described herein. In FIGS. 5A and 5B, techniques for a control plane function entity for session management (e.g., a converged control plane function for interworking, such as an SMF+PGW-C) for enabling 5G to 4G to 3G mobility are described. In FIGS. 6A and 6B techniques for a control plane function entity for mobility management (e.g., a control plane function, such as an MME) for enabling 5G to 4G to 3G mobility are described.

FIG. 5A is a flowchart 500A for describing a method for use in enabling 5G to 4G to 3G mobility for PDU sessions that are created or modified in 5G, which may be facilitated by a control plane function entity for session management, according to some implementations of the present disclosure. More specifically, the method may be performed by a converged control plane function entity for session management (e.g., which is or includes an SMF+PGW-C), which may be part of a converged core architecture for interworking. The method may be embodied in a computer program product which includes a non-transitory computer readable medium and instructions stored in the non-transitory computer readable medium, where the instructions are executable by one or more processors of a network node having the control plane function entity for session management.

A UE may operate for communications in the 5GS (via an NG-RAN, gNB), but subsequently need to communicate in the EPS (via an E-UTRAN, eNB) (e.g., responsive to a relocation with 5G coverage loss, or due to “EPS fallback” for a voice call). Beginning at a start block 502 of FIG. 5A, the control plane function entity may communicate one or more messages in a procedure for a handover of a session of the UE from the 5GS to the EPS (step 504 of FIG. 5A). In some implementations, the one or more messages that are communicated in step 504 may be those in the procedure described in call flow diagram 400 of FIGS. 4A, 4B, and 4C, or those in 5GS to EPS handover using N26 interface as specified in FIG. 4.11.1.2.1-1 of 3GPP TS 23.502. Note that, in the event that the session of the UE was originally established in the 5GS, or that QoS parameters of a QoS Flow of the session were modified while the UE was in the 5GS, then only EPS bearer QoS parameters are provided in the handover procedure (i.e., not the 2G/3G parameters) according to current conventional operation.

Upon completion of the procedure for the handover, the control plane function entity may identify whether one or more indications indicate a need to provide 2G and/or 3G parameters (step 506 of FIG. 5A). In some implementations, completion of the procedure for the handover may be identified upon completion of step 22 or step 24 in FIG. 4C, or upon completion of (one of the few) final step(s) of FIG. 4.11.1.2.1-1 of 3GPP TS 23.502. In some implementations, the need to provide the 2G and/or 3G parameters may be a result of identifying that the UE supports communications for 2G and/or 3G. In further implementations, the need to provide the 2G and/or 3G parameters may be a result of identifying that the session was established in the 5GS, and/or that QoS parameters of a QoS Flow of the session was modified while the UE was in the 5GS. Here, the control plane function entity may set an indication in memory in response to identifying a session being established in 5GS and/or QoS parameters being modified while the UE is in 5GS.

Based on identifying the one or more indications which indicate the need to provide the 2G and/or 3G parameters, the control plane function entity may communicate one or more messages in a bearer modification procedure with a bearer QoS update (step 508 of FIG. 5A). On the other hand, based on identifying that the one or more indications fail to indicate the need to provide the 2G and/or 3G parameters, the control plane function entity may refrain from communicating the one or more messages of the bearer modification procedure with the bearer QoS update. More particularly in relation to step 508, the bearer modification procedure may be the PGW bearer modification with bearer QoS update in accordance with 3GPP TS 23.401, clause 5.4.2.1.

In some implementations of step 508, communicating the one or more messages in the bearer modification procedure for the handover of the session may involve sending to the SGW a message which indicates an update bearer request. The message which indicates the update bearer request may be subsequently communicated from the SGW to an MME which is configured to select the 2G and/or 3G parameters based on EPS bearer QoS parameters of the session (e.g., via a mapping table) and store the 2G and/or 3G parameters in a context, for subsequent communication of the 2G and/or 3G parameters to the UE. In some implementations, the 2G and/or 3G parameters may include a QoS Negotiated, a Radio Priority, and/or a Packet Flow ID. In some further implementations, the MME may be further configured to create a transaction identifier (TI) associated with the session, for the subsequent communication along with the 2G and/or 3G parameters to the UE. The 2G and/or 3G parameters (and TI) may be stored at the UE for subsequent use in 2G/3G communications, for example, if a subsequent procedure for a handover of the session from the EPS to 2G/3G occurs (optional step 510 of FIG. 5A).

FIG. 5B is a call flow diagram 500B for describing a call flow for enabling 5G to 4G to 3G mobility for PDU sessions that are created or modified in 5G, which may be facilitated by the control plane function entity for session management (e.g., SMF+PGW-C 152), according to some implementations of the present disclosure. The control plane function entity for session management may operate in the same or similar manner as that described in relation to FIG. 5A.

UE 110 may operate for communications in the 5GS (via an NG-RAN, gNB), but subsequently need to communicate in the EPS (via an E-UTRAN, eNB 124) (e.g., responsive to a relocation with 5G coverage loss, or due to “EPS fallback” for a voice call). Accordingly, a procedure for a handover of a session of UE 110 from the 5GS to the EPS may be performed (step 0 of FIG. 5B). In some implementations, the procedure in call flow diagram 400 of FIGS. 4A, 4B, and 4C may be performed, or the procedure described as the 5GS to EPS handover using N26 interface as specified in FIG. 4.11.1.2.1-1 of 3GPP TS 23.502 may be performed. Note that, in the event that the session of the UE was originally established in the 5GS, or that QoS parameters of a QoS Flow of the session were modified while the UE was in the 5GS, then only EPS bearer QoS parameters are provided in the handover procedure (i.e., not the 2G/3G parameters) according to current conventional operation.

Upon completion of the procedure for the handover, SMF+PGW-C 152 may identify whether one or more indications indicate a need to provide 2G and/or 3G parameters. In some implementations, completion of the procedure for the handover may be identified upon completion of step 22 or step 24 in FIG. 4C, or upon completion of (one of the few) final step(s) of FIG. 4.11.1.2.1-1 of 3GPP TS 23.502. In some implementations, the need to provide the 2G and/or 3G parameters may be a result of identifying that UE 110 supports communications for 2G and/or 3G. In further implementations, the need to provide the 2G and/or 3G parameters may be a result of identifying that the session was established in the 5GS, and/or that QoS parameters of a QoS Flow of the session was modified while UE 110 was in the 5GS. Here, the control plane function entity may set an indication in memory in response to identifying a session being established in 5GS and/or QoS parameters being modified while UE 110 is in 5GS.

Based on identifying the one or more indications which indicate the need to provide the 2G and/or 3G parameters, SMF+PGW-C 152 may initiate a bearer modification procedure with a bearer QoS update (step 1 of FIG. 5B). On the other hand, based on identifying that the one or more indications fail to indicate the need to provide the 2G and/or 3G parameters, SMF+PGW-C 152 may refrain from initiating the bearer modification procedure with the bearer QoS update. More particularly in relation to step 1 of FIG. 5B, the bearer modification procedure may be the PGW bearer modification with bearer QoS update in accordance with 3GPP TS 23.401, clause 5.4.2.1, to modify the default EPS bearer. As the QoS of UE 110 is indicated to have changes, MME 120 will provide the 2G/3G parameters to UE 110. As there is no TI associated with the MME 120, the MME 120 will create the TI for the EPS bearer and store it in its context.

Steps of the bearer modification procedure of step 1 of FIG. 5B adapted according to the present disclosure are now described. At the SMF+PGW-C 152, initiating the bearer modification with bearer QoS update may involve sending to SGW 122 a message which indicates an update bearer request (step 2 of FIG. 5B). The message which indicates the update bearer request may be subsequently communicated from the SGW 122 to MME 120 (step 3 of FIG. 5B). MME 120 is configured to select or determine the 2G and/or 3G parameters based on EPS bearer QoS parameters of the session (e.g., via a mapping table) and store the 2G and/or 3G parameters in a context. In some implementations, the 2G and/or 3G parameters may include a QoS Negotiated, a Radio Priority, and/or a Packet Flow ID. In some further implementations, the MME 120 may be further configured to create a TI associated with the session and store in it in its context. MME 120 may then send to eNB 124 a message which indicates a bearer modify request and a session management request (step 4 of FIG. 5B). The session management request may include the 2G and/or 3G parameters (and the TI). Accordingly, if UE 110 has UTRAN or GERAN capabilities and the network supports mobility to UTRAN or GERAN, MME 120 may use the EPS bearer QoS parameters to derive corresponding PDP context parameters, QoS Negotiated (R99 QoS profile), Radio Priority, Packet Flow ID and include them in the session management request.

The eNB 124, in turn, will send to UE 110 a radio resource control (RRC) reconfiguration message which includes the information (step 5 of FIG. 5B). UE 110 may receive and process the RRC connection reconfiguration message, storing the 2G and/or 3G parameters (and TI) in its context. UE 110 may respond to eNB 124 with an RRC connection complete message (step 6 of FIG. 5B). As a response to the bearer modify request, the eNB 124 may send to MME 120 a message which indicates a bearer modify response (step 7 of FIG. 5B). UE 110 may also send a direct transfer message to eNB 124 (step 8 of FIG. 5B), including a session management response which is further sent to MME 120 (step 9 of FIG. 5B) as a response to the session management request. In response, MME 120 may send to SGW 122 a message which indicates an update bearer response (step 10 of FIG. 5B). SGW 122 may receive and process the message, and in turn, send to SMF+PGW-C 152 a message which indicates an update bearer response (step 11 of FIG. 5B). As is apparent, the 2G and/or 3G parameters (and TI) are stored at UE 110 for subsequent use in 2G/3G communications, for example, for use if and when a subsequent procedure for a handover of the session from the EPS to 2G/3G occurs (i.e., access via GERAN or UTRAN) per 3GPP specifications (optional step 12 of FIG. 5B).

FIG. 6A is a flowchart 600A for describing a method for use in enabling 5G to 4G to 3G mobility for PDU sessions that are created or modified in 5G, which may be facilitated by a control plane function entity for mobility management, according to some implementations of the present disclosure. More specifically, the method may be performed by the control plane function entity for mobility management (e.g., which is or includes an MME), which may be part of a converged core architecture for interworking. The method may be embodied in a computer program product which includes a non-transitory computer readable medium and instructions stored in the non-transitory computer readable medium, where the instructions are executable by one or more processors of a network node having the control plane function entity for mobility management.

A UE may operate for communications in the 5GS (via an NG-RAN, gNB), but subsequently need to communicate in the EPS (via an E-UTRAN, eNB) (e.g., responsive to a relocation with 5G coverage loss or due to “EPS fallback” for a voice call). Beginning at a start block 602 of FIG. 6A, the control plane function entity may communicate one or more messages in a procedure for a handover of a session of the UE from the 5GS to the EPS (step 604 of FIG. 6A). In some implementations, the one or more messages that are communicated in step 604 may be those in the procedure described in call flow diagram 400 of FIGS. 4A, 4B, and 4C, or those in 5GS to EPS handover using N26 interface as specified in FIG. 4.11.1.2.1-1 of 3GPP TS 23.502. Note that, in the event that the session of the UE was originally established in the 5GS, or that QoS parameters of a QoS Flow of the session were modified while the UE was in the 5GS, then only EPS bearer QoS parameters are provided in the handover procedure (i.e., not the 2G/3G parameters) according to current conventional operation.

Upon completion of the procedure for the handover, the control plane function entity may identify whether one or more indications indicate a need to provide 2G and/or 3G parameters (step 606 of FIG. 6A). In some implementations, completion of the procedure for the handover may be identified upon completion of step 23 in FIG. 4C, or upon completion of (one of the few) final step(s) of FIG. 4.11.1.2.1-1 of 3GPP TS 23.502. In some implementations, the need to provide the 2G and/or 3G parameters may be a result of identifying that the UE supports communications for 2G and/or 3G. In further implementations, the need to provide the 2G and/or 3G parameters may be a result of determining that 2G and/or 3G parameters for the UE are not stored in the context at the control plane function entity.

Based on identifying the one or more indications which indicate the need to provide the 2G and/or 3G parameters, the control plane function entity may initiate a procedure for bearer modification, which includes the sending of a modify bearer request including the 2G and/or 3G parameters (step 608 of FIG. 6A). On the other hand, based on identifying that the one or more indications fail to indicate the need to provide the 2G and/or 3G parameters, the control plane function entity may refrain from initiating the procedure for the bearer modification. In some implementations, the control plane function entity may select or determine the 2G and/or 3G parameters in accordance with EPS bearer QoS parameters of the session (e.g., via a mapping table). In some implementations, the 2G and/or 3G parameters may include a QoS Negotiated, a Radio Priority, and/or a Packet Flow ID.

More particularly in relation to step 608, the control plane function entity may send, to an eNB, a NAS transport message which includes the message which indicates the modify bearer request including the 2G and/or 3G parameters. The NAS transport message which includes the message which indicates the modify bearer request may be subsequently communicated from the eNB to the UE. In some further implementations, the MME may be further configured to provide a TI associated with the session, for the subsequent communication to the UE along with the 2G and/or 3G parameters. The 2G and/or 3G parameters (and TI) may be stored at the UE for subsequent use in 2G/3G communications, for example, if a subsequent procedure for a handover of the session from the EPS to 2G/3G occurs (optional step 610 of FIG. 6A).

FIG. 6B is a call flow diagram 600B for describing a call flow for enabling 5G to 4G to 3G mobility for PDU sessions that are created or modified in 5G, which may be facilitated by the control plane function entity for mobility management (e.g., MME 120), according to some implementations of the present disclosure. The control plane function entity for mobility management may operate in the same or similar manner as that described in relation to FIG. 6A.

UE 110 may operate for communications in the 5GS (via an NG-RAN, gNB), but subsequently need to communicate in the EPS (via an E-UTRAN, eNB 124) (e.g., responsive to a relocation with 5G coverage loss, or due to “EPS fallback” for a voice call). Accordingly, a procedure for a handover of a session of UE 110 from the 5GS to the EPS may be performed (step 0 of FIG. 6B). In some implementations, the procedure in call flow diagram 400 of FIGS. 4A, 4B, and 4C may be performed, or the procedure described as the 5GS to EPS handover using N26 interface as specified in FIG. 4.11.1.2.1-1 of 3GPP TS 23.502 may be performed. Note that, in the event that the session of UE 110 was originally established in the 5GS, or that QoS parameters of a QoS Flow of the session were modified while UE 110 was in the 5GS, then only EPS bearer QoS parameters are provided in the handover procedure (i.e., not the 2G/3G parameters) according to current conventional operation.

Upon completion of the procedure for the handover, MME 120 may identify whether one or more indications indicate a need to provide 2G and/or 3G parameters (step 1 of FIG. 6B). In some implementations, completion of the procedure for the handover may be identified upon completion of step 23 in FIG. 4C, or upon completion of (one of the few) final step(s) of FIG. 4.11.1.2.1-1 of 3GPP TS 23.502. In some implementations, the need to provide the 2G and/or 3G parameters may be a result of determining that 2G and/or 3G parameters for the UE 110 are not stored in a session management (SM) context for UE 110 at MME 120. In some further implementations, the need to provide the 2G and/or 3G parameters may be a result of identifying that UE 110 indeed supports communications for 2G and/or 3G. In some implementations, MME 120 may set an indication in memory in response to identifying a session being established in 5GS and/or QoS parameters being modified while UE 110 is in 5GS.

Based on identifying the one or more indications which indicate the need to provide the 2G and/or 3G parameters, MME 120 may initiate a procedure for bearer modification, which includes the sending of a modify bearer request including the 2G and/or 3G parameters (step 2 of FIG. 6B). In some implementations, the 2G and/or 3G parameters may include a QoS Negotiated, a Radio Priority, and/or a Packet Flow ID. On the other hand, based on identifying that the one or more indications fail to indicate the need to provide the 2G and/or 3G parameters, MME 120 may refrain from initiating the procedure for the bearer modification. In some implementations, prior to step 2 of FIG. 6B, MME 120 may select or determine the 2G and/or 3G parameters in accordance with EPS bearer QoS parameters of the session (e.g., via a mapping table). In further implementations, MME may create a TI associated with the session, for the subsequent communication to UE 110 along with the 2G and/or 3G parameters.

More particularly in relation to step 2 of FIG. 6B, MME 120 may send, to eNB 124, a DL NAS transport message which includes the message which indicates the modify bearer request including the 2G and/or 3G parameters. Then, the eNB 124 may send a DL NAS transfer message which includes the message which indicates the modify bearer request to UE 110 (step 3 of FIG. 6B). UE 110 may receive and process the DL NAS transfer message, storing the 2G and/or 3G parameters (and TI) in its context. UE 110 may respond to eNB 124 with uplink (UL) NAS transfer message which includes a message which indicates a modify bearer response (step 4 of FIG. 6B). In turn, the eNB 124 may send to MME 120 a UL NAS transport message which includes the message which indicates the modify bearer response (step 5 of FIG. 6B). The 2G and/or 3G parameters (and TI) may be stored at the UE 110 for subsequent use in 2G/3G communications, for example, if a subsequent procedure for a handover of the session from the EPS to 2G/3G occurs per 3GPP specifications (optional step 6 of FIG. 6B). Steps 2 through 6 may be repeated for each EPS bearer of UE 110.

Advantageously, 5G to 4G to 3G mobility for UEs is now achievable even in cases where specified interworking operation does not successfully provide 2G/3G parameters for the UE (e.g., for use if and when the UE is further handed over to a 2G/3G system). In FIGS. 5A-5B, techniques and mechanisms that leverage existing specification procedures and/or messaging/processing steps are provided for efficiency. Here, in some implementations, little to no changes to the functionality of the MME need to be made. In FIGS. 6A-6B, alternative techniques and mechanisms that also leverage existing messaging/processing steps are provided. Further efficiencies in these techniques are provided by refraining from the performance of processing steps in cases where 2G and/or 3G parameters are not needed for mobility.

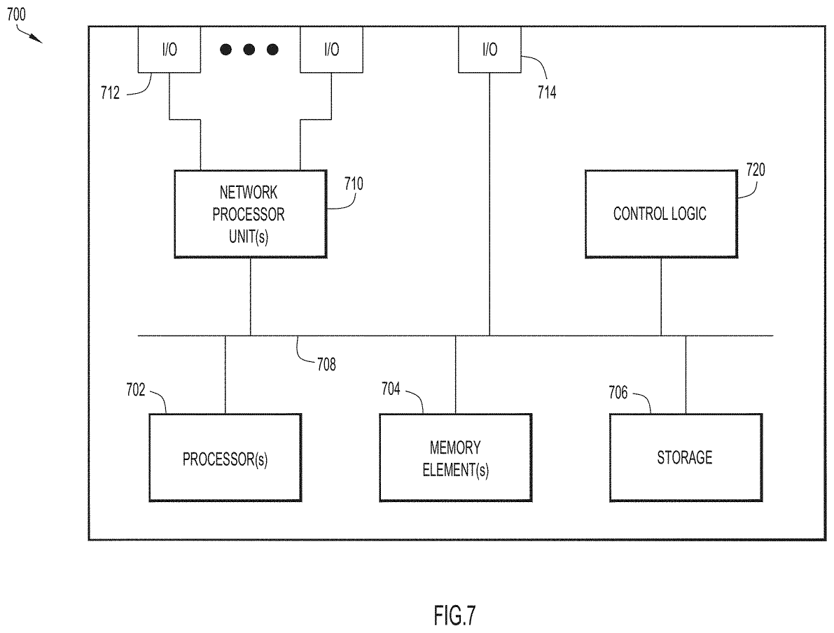

FIG. 7 illustrates a hardware block diagram of a computing device 700 that may perform functions associated with operations discussed herein in connection with the techniques described in relation to the above figures. In various embodiments, a computing device, such as computing device 700 or any combination of computing devices 700, may be configured as any entity/entities as discussed for the techniques depicted in connection with the figures in order to perform operations of the various techniques discussed herein. In particular, computing device 700 may perform operations of a control plane function entity (e.g., a PGW-C, an SMF, an SMF+PGW-C, etc.) for operation in accordance with the method of FIG. 5A or 6A, or for operation according to the call flow in FIG. 5B or 6B.

In at least one embodiment, computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, and/or any other I/O port(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Thus, techniques and mechanisms for enabling 5G to 4G to 3G mobility for PDU sessions that are created or modified in 5G have been described.

In one illustrative example, a method may be performed at a control plane function entity for session management which involves communicating one or more messages in a procedure for a handover of a session of a UE from a 5GS to an EPS; after the procedure for the handover, identifying whether one or more indications indicate a need to provide 2G and/or 3G parameters; and based on identifying that the one or more indications indicate the need to provide the 2G and/or the 3G parameters, communicating one or more messages in a bearer modification procedure with a bearer QoS update. On the other hand, based on identifying that the one or more indications fail to indicate the need, the method involves refraining from communicating the one or more messages in the bearer modification procedure with the bearer QoS update. In some implementations, the control plane function entity for session management may comprise a converged control plane function entity for interworking, and more particularly, may comprise an SMF+PGW-C.

In some implementations, the need to provide the 2G and/or the 3G parameters may be a result of identifying that the UE supports communications for 2G and/or 3G, and/or identifying that the session was established in the 5GS, or that QoS parameters of a QoS Flow of the session was modified while the UE was in the 5GS. In some implementations, the 2G and/or the 3G parameters may comprise one or more of a QoS Negotiated, a Radio Priority, and a Packet Flow ID.

In some implementations, the bearer modification procedure may comprise a PDN GW initiated bearer modification with a bearer QoS update. In some implementations, communicating the one or more messages in the bearer modification procedure for the handover of the session further comprises sending a message which indicates an update bearer request. In some implementations, communicating the one or more messages in the bearer modification procedure for the handover of the session further comprises sending to a SGW a message which indicates an update bearer request, for subsequent communication to a MME that is configured to select the 2G and/or the 3G parameters based on EPS bearer QoS parameters of the session and store the 2G and/or the 3G parameters in a context, for the subsequent communication of the 2G and/or the 3G parameters to the UE. In some implementations, communicating the one or more messages in the bearer modification procedure for the handover of the session further comprises sending to a SGW a message which indicates an update bearer request, for the subsequent communication to a MME that is configured to select the 2G and/or the 3G parameters based on EPS bearer QoS parameters of the session, store the 2G and/or the 3G parameters in a context, and create a TI associated with the session, for the subsequent communication of the 2G and/or the 3G parameters and the TI to the UE.

In another illustrative example, a method may be performed at a control plane function entity for mobility management which involves communicating one or more messages in a procedure for a handover of a session of a UE from a 5GS to an EPS; after the procedure for the handover, identifying whether one or more indications indicate a need to provide 2G and/or 3G parameters; and based on identifying that the one or more indications indicate the need to provide the 2G and/or the 3G parameters, sending a message which indicates a modify bearer request including the 2G and/or the 3G parameters. On the other hand, based on identifying that the one or more indications fail to indicate the need, refraining from sending the message which indicates the modify bearer request including the 2G and/or the 3G parameters. In some implementations, the control plane function entity for mobility management may comprise an MME.

In some implementations, sending the message which indicates the modify bearer request including the 2G and/or the 3G parameters may further comprises sending to an eNB a NAS transport message comprising the message which indicates the modify bearer request. In some implementations, the need to provide the 2G and/or the 3G parameters may be a result of identifying that the UE supports communications for 2G and/or 3G, and/or identifying that the session was established in the 5GS, or that QoS parameters of a QoS Flow of the session was modified while the UE was in the 5GS. In some implementations, the 2G and/or the 3G parameters may comprise one or more of a QoS Negotiated, a Radio Priority, and a Packet Flow ID. In some implementations, the method may further comprise selecting the 2G and/or the 3G parameters in accordance with EPS bearer QoS parameters of the session.

In a further illustrative example, a network node may comprise one or more processors; one or more interfaces to connect for network communication; one or more memory elements for storing instructions executable by the one or more processors for operation as a control plane function entity for session management operative for interworking, including for performing the processing/messaging steps of the method(s) as described. In yet another illustrative example, a computer program product may comprise a non-transitory computer readable medium and instructions stored in the non-transitory computer readable medium, where the instructions are executable by one or more processors of a network node having a control plane function entity for mobility management operative for interworking, including for performing the processing/messaging steps of the method(s) as described.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), VLAN, wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, entities for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combined multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
at a control plane function entity for session management,
communicating one or more messages in a procedure for a handover of a session of a user equipment (UE) from a Fifth Generation System (5GS) to an Evolved Packet System (EPS);
after the procedure for the handover, identifying whether one or more indications indicate a need to provide Second Generation (2G) and/or Third Generation (3G) parameters; and
based on identifying that the one or more indications indicate the need to provide the 2G and/or the 3G parameters, communicating one or more messages in a bearer modification procedure with a bearer Quality of Service (QoS) update.

2. The method of claim 1, further comprising:
at the control plane function entity for session management,
based on identifying that the one or more indications fail to indicate the need, refraining from communicating the one or more messages in the bearer modification procedure with the bearer QoS update.

3. The method of claim 1, wherein the bearer modification procedure comprises a packet data network (PDN) gateway (GW) initiated bearer modification with a bearer QoS update.

4. The method of claim 1, wherein communicating the one or more messages in the bearer modification procedure for the handover of the session further comprises:
sending a message which indicates an update bearer request.

5. The method of claim 1, wherein communicating the one or more messages in the bearer modification procedure for the handover of the session further comprises:
sending to a serving gateway (SGW) a message which indicates an update bearer request, for subsequent communication to a mobility management entity (MME) that is configured to select the 2G and/or the 3G parameters based on EPS bearer QoS parameters of the session and store the 2G and/or the 3G parameters in a context, for the subsequent communication of the 2G and/or the 3G parameters to the UE.

6. The method of claim 1, wherein communicating the one or more messages in the bearer modification procedure for the handover of the session further comprises:
sending to a serving gateway (SGW) a message which indicates an update bearer request, for subsequent communication to a mobility management entity (MME) that is configured to select the 2G and/or the 3G parameters based on EPS bearer QoS parameters of the session, store the 2G and/or the 3G parameters in a context, and create a transaction identifier (TI) associated with the session, for the subsequent communication of the 2G and/or the 3G parameters and the TI to the UE.

7. The method of claim 1, wherein the need to provide the 2G and/or the 3G parameters is a result of:
identifying that the UE supports communications for 2G and/or 3G; and
identifying that the session was established in the 5GS, or that QoS parameters of a QoS Flow of the session was modified while the UE was in the 5GS.

8. The method of claim 1, wherein the 2G and/or the 3G parameters comprise one or more of a QoS Negotiated, a Radio Priority, and a Packet Flow ID.

9. The method of claim 1, wherein the control plane function entity for session management comprises a converged control plane function entity for interworking.

10. The method of claim 9, wherein the converged control plane function entity for interworking comprises a session management function (SMF) plus packet data network gateway (PGW-C) (SMF+PGW-C).

11. A network node comprising:
one or more processors;
one or more interfaces to connect for network communication;
one or more memory elements for storing instructions executable by the one or more processors for operation as a converged control plane function entity for session management operative for interworking, including for:
communicating one or more messages in a procedure for a handover of a session of a user equipment (UE) from a Fifth Generation System (5GS) to an Evolved Packet System (EP S);
after the procedure for the handover, identifying whether one or more indications indicate a need to provide Second Generation (2G) and/or Third Generation (3G) parameters; and
based on identifying that the one or more indications indicate the need to provide the 2G and/or the 3G parameters, communicating one or more messages in a bearer modification procedure with a bearer Quality of Service (QoS) update.

12. The network node of claim 11, wherein the instructions are further executable by the one or more processors for:
based on identifying that the one or more indications fail to indicate the need to provide the 2G and/or the 3G parameters, refraining from communicating the one or more messages in the bearer modification procedure with the bearer QoS update.

13. The network node of claim 11, wherein the bearer modification procedure comprises a packet data network (PDN) gateway (GW) initiated bearer modification with a bearer QoS update.

14. The network node of claim 11, wherein the instructions are further executable by the one or more processors for communicating the one or more messages in the bearer modification procedure for the handover of the session by:
sending to a serving gateway (SGW) a message which indicates an update bearer request, for subsequent communication to a mobility management entity (MME) that is configured to select the 2G and/or the 3G parameters based on EPS bearer QoS parameters of the session and store the 2G and/or the 3G parameters in a context, for the subsequent communication of the 2G and/or the 3G parameters to the UE.

15. A method comprising:
at a control plane function entity for mobility management,
communicating one or more messages in a procedure for a handover of a session of a user equipment (UE) from a Fifth Generation System (5GS) to an Evolved Packet System (EPS);
after the procedure for the handover, identifying whether one or more indications indicate a need to provide Second Generation (2G) and/or Third Generation (3G) parameters; and
based on identifying that the one or more indications indicate the need to provide the 2G and/or the 3G parameters, sending a message which indicates a modify bearer request including the 2G and/or the 3G parameters.

16. The method of claim 15, further comprising:
at the control plane function entity for mobility management,
based on identifying that the one or more indications fail to indicate the need to provide the 2G and/or the 3G parameters, refraining from sending the message which indicates the modify bearer request including the 2G and/or the 3G parameters.

17. The method of claim 15, wherein sending the message which indicates the modify bearer request including the 2G and/or the 3G parameters further comprises:
sending to an evolved Node B (eNB) a Non-Access Stratum (NAS) transport message comprising the message which indicates the modify bearer request.

18. The method of claim 15, further comprising;
at the control plane function entity for mobility management,
selecting the 2G and/or the 3G parameters in accordance with EPS bearer QoS parameters of the session.

19. The method of claim 15, wherein the need to provide the 2G and/or the 3G parameters is a result of:
identifying that the UE supports communications for 2G and/or 3G; and
identifying that the 2G and/or the 3G parameters for the UE are not stored in a context associated with the UE.

20. The method of claim 15, wherein:
the control plane function entity for mobility management comprises a mobility management entity (MME), and
the 2G and/or the 3G parameters comprise one or more of a QoS Negotiated, a Radio Priority, and a Packet Flow ID.
